(19) United States
(12) Patent Application Publication
(10) Pub. No.: US 2019/0377755 A1
(43) Pub. Date: Dec. 12, 2019

(54) Device for Mood Feature Extraction and Method of the Same

(71) Applicants: Kuo-Ching Chiang, New Taipei City (TW); Yi-Chuan Cheng, Changhua County (TW)

(72) Inventors: Kuo-Ching Chiang, New Taipei City (TW); Yi-Chuan Cheng, Changhua County (TW)

(21) Appl. No.: 16/438,558

(22) Filed: Jun. 12, 2019

(30) Foreign Application Priority Data
Jun. 12, 2018 (TW) 107120210

(51) Int. Cl. G06F 16/68; G06F 3/01; H04M 1/725; G06F 3/0481; G06K 9/00; G10L 25/63

(52) U.S. Cl. CPC G06F 16/686; G06F 3/015; H04M 1/72558; H04M 1/72586; G06K 9/00335; G10L 25/63; H04M 2201/42; G06F 3/0481

(57) ABSTRACT

A device for mood feature extraction includes a control unit, a display coupled to the control unit, a memory coupled to the control unit, and a mood feature capture module coupled to the control unit to extract a facial image of a user to generate a mood feature of the user. A selection module can be activated based-on the mood feature.

### CROSS-REFERENCE TO RELATED APPLICATIONS

The present application claims the benefit of TAIWAN Patent Application Serial Number 107120210 filed on Jun. 12, 2018, which is herein incorporated by reference.

### TECHNICAL FIELD

The present invention relates to electronic devices, and particularly to a device with mood feature extraction function and the method of the same.

### BACKGROUND OF RELATED ARTS

Cellular communications systems typically include multiple base stations for communicating with mobile stations in various geographical transmission areas. Each base station provides an interface between the mobile station and a telecommunications network. When a subscriber within the same system or within an external system wishes to call a mobile subscriber within this system, the network must have information on the actual location of the mobile telephone.

Recently, the prices of the mobile phones have greatly decreased, and thus the general public can afford to pay such a price. It is quite common that a person owns more than one mobile phone. The manufacturer of the mobile phone has to launch new models with different appearances, functions and styles more frequently to attract the buyer's attention and occupy beneficial market share.

Because of the development of the information technology, the information can be exchanged at higher speed and higher capacity. The Internet is designed as an open structure in which information can be exchanged freely without limitation. The fifth generation (5G) mobile phones are about to become popular. Therefore, there is a need for the specific communication service which can exchange information instantly. For example, downloading and viewing live video at high speed have become practicable by means of the fifth generation communication network or Internet.

Based on the aforementioned, the present invention arises therefrom.

### SUMMARY

In one aspect, the present invention discloses a mood feature extraction device including: a control unit; a display coupled to the control unit; a memory coupled to the control unit; and a mood feature capture module coupled to the control unit to capture a mood feature of a user and activate a selection module based on the mood feature.

In one embodiment, the selection module may comprise a music selection module or a merchandise selection module.

In one embodiment, the selection module may be disposed in network store, music website, music streaming system, unmanned store, jukebox device or the mood feature extraction device. In one embodiment, the mood feature extraction device may comprise smart phone, tablet PC, smart speaker, augmented reality (AR) device, virtual reality (VR) device or automobile sound box.

The present invention may further comprise a mood recognition module disposed in network store, music website, music streaming system, unmanned store, jukebox device or the mood feature extraction device. In one embodiment, the mood feature extraction device may comprise smart phone, tablet PC, smart speaker, augmented reality (AR) device, virtual reality (VR) device or automobile sound box.

The present invention may further comprise a mood related merchandise database or a mood related music database disposed in network store, music website, music streaming system, unmanned store, jukebox device or the mood feature extraction device. In one embodiment, the mood feature extraction device may comprise smart phone, tablet PC, smart speaker, augmented reality (AR) device, virtual reality (VR) device or automobile sound box.

In one embodiment, the mood feature capture module may comprise capture of face or EEG (electroencephalograph) signal, so as to generate the mood feature.

The present invention discloses a method of employing a mood feature to play music, the method including: capturing a mood feature of a user by a mood feature capture module; recognizing the mood feature by a mood recognition module; transmitting the mood feature to a mood related music module; and playing related music based on the mood feature, wherein the mood related music module is disposed in a mood feature extraction device or a remote device.

The present invention discloses a method of employing a mood feature to recommend a merchandise, the method including: capturing a mood feature of a user by a mood feature capture module; recognizing the mood feature by a mood recognition module; transmitting the mood feature to a mood related merchandise module; and recommending related merchandise based on the mood feature.

In one embodiment, the mood feature capture module may be disposed in network store, unmanned store or a mood feature extraction device. In one embodiment, the mood feature extraction device may comprise mobile phone, smart phone, tablet PC, smart speaker, jukebox, augmented reality (AR) device, virtual reality (VR) device or automobile sound playing device.

These and other advantages will become apparent from the description of the following preferred embodiment accompanied with the attached drawings and claims.

### BRIEF DESCRIPTION OF THE DRAWINGS

The aforementioned components and the other features and advantages of the present invention will become apparent by reading the following detailed description of the preferred embodiment together with the drawings.

FIG. 1 is a diagram of a user terminal device in accordance with one embodiment of the present invention;

FIG. 2 is a diagram of a user terminal device in accordance with another embodiment of the present invention;

FIGS. 3-6 are diagrams of the user motion control module;

FIG. 7 is a diagram of a mood feature extraction device with mood analysis function and the applying system thereof in accordance with one embodiment of the present invention;

FIG. 8 is a flow chart of a device user logging in a system in accordance with one embodiment of the present invention;

FIG. 9 is a flow chart of applying the mood feature capture module in accordance with one embodiment of the present invention; and

FIG. 10 is a flow chart of applying the mood feature capture module in accordance with one embodiment of the present invention.

### DETAILED DESCRIPTION

The present invention will now be described with the preferred embodiments and aspects and these descriptions interpret structure and procedures of the present invention only for illustrating but not for limiting the Claims of the present invention. Therefore, except the preferred embodiments in the specification, the present invention may also be widely used in other embodiments.

At least two different communication networks and protocols may be included in the communication system and environment, for instance W-CDMA, CDMA2000, CDMA2001, TD-CDMA, TD-SCDMA, UWC-136, DECT, 4G, 5G communication service network, etc. A local area network may be coupled to the Internet. For example, the mobile phone terminal device of the user may be coupled to the mobile network. In the same way, the computers may be coupled to the Internet respectively. In one embodiment, the computer may be coupled to the Internet via the access point. It should be noted that the number of the terminal device may change, and the present invention may cover any possible number of terminal devices. These devices may include but are not limited to PDA, tablet PC, smart speaker, augmented reality (AR) device, virtual reality (VR) device, notebook and mobile phone or smart phone. All of these devices may access the Internet. The information exchange between these devices may be performed directly via the Internet.

The terminal devices may be located in different networks, for instance the Internet and the mobile communication network. An exchange service mechanism is bridged between the two different networks, such that the communication between the terminal devices in the two networks may be achieved. That is to say, the exchange service mechanism may relay and connect services between the systems or networks, which is known in the art. The access point (or hot spot) may be coupled to the Internet to provide an entrance to the local area network for wireless communication. One aspect of the present invention is that the system may include a portable device with at least dual network function. The device may transmit or receive data through the mobile communication network or the Internet. The transmitted or received data may include audio, video or audio and video.

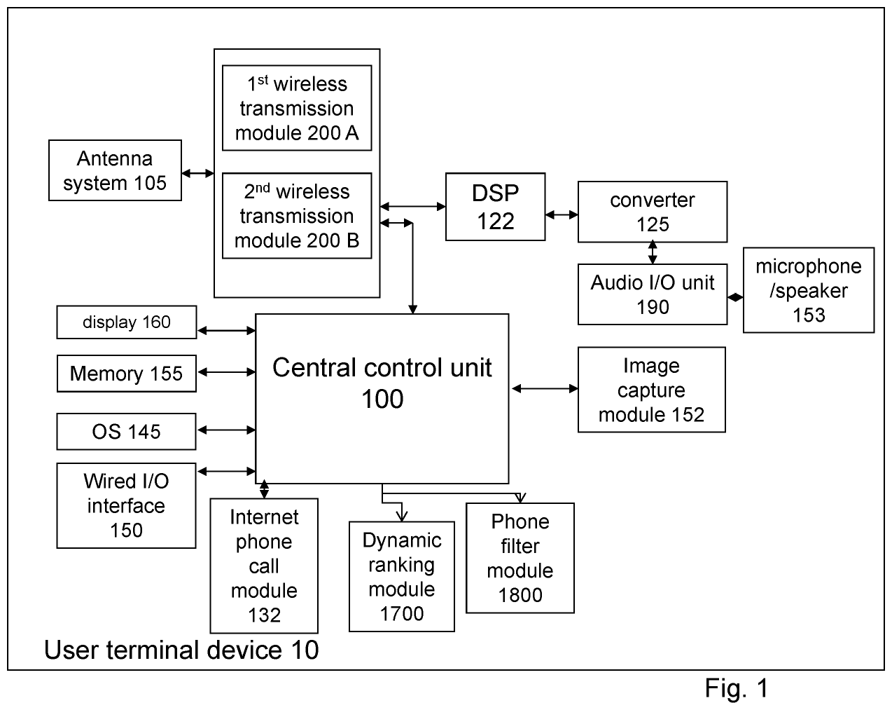

Referring to FIG. 1, it illustrates a functional diagram of a portable device 10 with dual network function. The dual way portable terminal device 10 has a SIM card connector to load a SIM card, which is known in the art. In other types of mobile phones such as PHS or some CDMA systems, the SIM card is not certainly necessary. The drawing is illustrated for describing the present invention, not for limiting the claims of the present invention. The portable terminal device or the device 10 may include a first wireless data transmission module 200A and a second wireless data transmission module 200B. The first wireless data transmission module 200A can be a video RF module for transmitting or receiving mobile signals, and aforementioned module is well known by skilled persons in the art. As well known, the RF module is coupled to an antenna system 105. The RF module may further include the base band processor. The antenna system is connected to a radio transceiver for transmitting or receiving signals. The wireless data transmission module 200A is compatible with various mobile communication protocols, such as W-CDMA, CDMA2000, CDMA2001, TD-CDMA, TD-SCDMA, UWC0136, DECT, 3G, 4G, 5G systems. These systems allow users to communicate through video telephone. The RF module may be introduced to perform transmission and reception of signals, frequency synchronization, base band processing, and digital signals processing, etc. The hardware interface of SIM card is used to contain (or insert) a SIM card. And finally, signals can be transmitted to the final actuators, that is, the audio I/O (input/output) unit 190, which may include speakers and microphones 153. The modules 200A and 200B may be formed by separate modules (chips) or an integrated chip.

The portable device 10 may be for instance portable electronic devices such as mobile phones, smart phones, smart speakers, AR devices, VR devices, PDAs, media players, GPSs, notebooks, tablet PCs, or game consoles.

The device 10 may also include a DSP (digital signal processor) 122, encoder/decoder (not shown) and A/D converter 125. The present invention may further comprises a central control unit 100, a display 162, OS (operation system) 145, and memory 155, wherein the memory 155 may include ROM, RAM, and nonvolatile FLASH memory. Aforementioned units can be coupled to the central control unit 100 respectively. The wired I/O interface 150 may be coupled to the central control unit 100, and it may be USB or IEEE 1394.

The device 100 may also include the second wireless data transmission module 200B. In one embodiment, the second wireless data transmission module 200B may employ a wireless short range (local) network module and may be compatible with LAN, MAN (metropolitan area network), or other network, such as Wi-Fi or 802.11x (x refers to a, b, g, n). “Short range” represents that communication distance is shorter than the mobile communication distance. An internet phone call module (software) 132 may be coupled to the central control unit 100, so as to transmit or receive audio, video or audio and video to/from the Internet via the wireless local transmission module. The internet phone call module (software) 132 may at least comply with VoIP (voice over internet protocol) network voice transmission technology specification. By utilizing the internet phone call module 132 and the wireless local area network module 200B, the user can employ the internet phone call module 132 to simultaneously transmit and receive audio, video or audio and video anytime and anywhere via the Internet. If the user wants to perform instant video transmission, an image capture module 152 is needed to be coupled to the central control unit 100 so as to capture the video image. The image capture module 152 may be digital camera or digital recorder. Therefore, a real time portable conference may be held anytime and anywhere. In another embodiment, the RF module may be omitted. If the device 10 includes 5G or higher level of RF module, the user can transmit video phone call at high speed via air. The efficiency thereof is greatly higher than the 3G or 4G mobile phone. Thus, the user can select to perform the video phone call via the Internet or the air according to his/her demand. If the device is located in the hot spot area, the user can choose to use the Internet phone call module to perform communication because of the cheaper transmission fee of the Internet phone call. If the device is located out of the hot spot area, the other choice for performing video communication may be provided. Typically, WCDMA signal is relatively not limited to geography, but the transmission fee thereof is higher. The present invention enables the user to select proper wireless module to perform video communication. If the user selects to perform video communication via WiFi or WiMax, the method includes coupling to the Internet or hot spot and activating the Internet phone call module (software). Then, the audio signal may be input via the speaker while the image data is captured by the image capture device. Subsequently, the image data and the audio signals are converted from analog signals into digital signals. After the conversion, the image data and the audio signals are combined, compressed and processed to form a data stream. Therefore, the data can be actually transmitted to the receiver. When transmitting digital music and video, it is considered preferable that the output of the channel decoder has a bit error rate (BER) of less than about 10-5. The bits in a given source coded bit stream (e.g., a compressed audio, image or video bit stream) often have different levels of importance in terms of their impact on reconstructed signal quality. Thus, it is generally desirable to provide different levels of channel error protection for different portions of the source coded bit stream. Techniques for use in providing such unequal error protection (UEP) through the use of different channel codes are described in U.S. patent application Ser. No. 09/022,114, filed Feb. 11, 1998, and entitled “Unequal Error Protection for Perceptual Audio Coders.” A source coded bit stream is divided into different classes of bits, with different levels of error protection being provided for the different classes of bits.

The device may be coupled to the Internet via the wired input/output interface or the wireless local area network module 200B to upload or download data including digital data such as text format, image format, audio signal or video signal. The wired input/output interface may be coupled to the central control unit 100. The application of the device is quite economical and convenient. Furthermore, when the local area wireless transmission module detects the signal of the Internet network, the user can make a phone call to others through the Internet phone call module to save transmission fee. Otherwise, the user may employ WCDMA for video communication. The portable real-time video conference is possible by implementation of the present invention. Further, the present invention provides dual modes (3G or higher level or internet video phone) portable audio/video communication, synchronously.

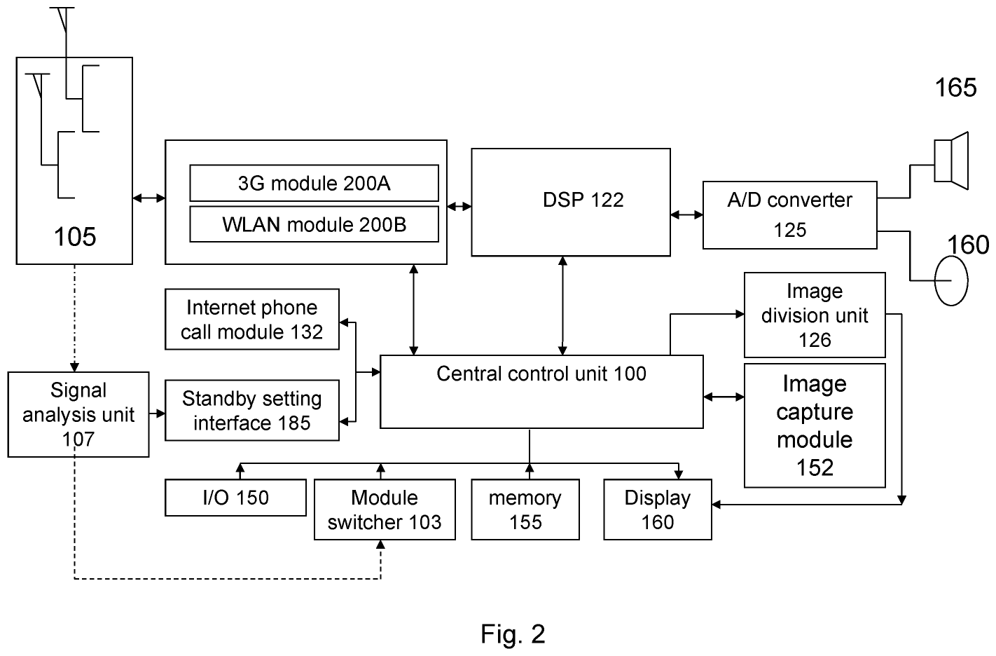

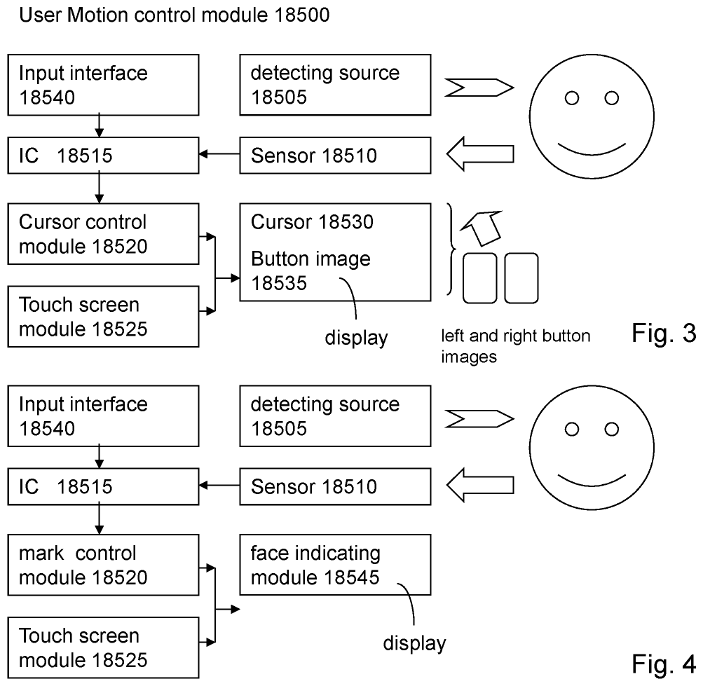

FIG. 2 illustrates another embodiment of the present invention. Almost all of the elements are the same as those in FIG. 1, and therefore the detailed descriptions thereof are omitted. In this embodiment, a signal analysis unit 107 is provided to analyze the signal strength of dual communication module, the first and second wireless transmission module 200A and 200B. The analysis result will be fed into the module switcher 103 to automatically switch between modules or manually set the modules via the standby setting interface 185. In order to implant multi-parties video communication, the device 10 may include an image division unit 126 coupled to the central control unit 10 to divide the displaying area on the display to display the received images synchronously. The received images will be assigned to the divided displaying area on the display and the displaying areas may be separated, overlapped or partially overlapped. Please refer to FIG. 3. A plurality of fed images are transmitted to a multi-tasking module for processing the received images from multi-parties. The images will be processed by the image division unit 126 before sending the image data signals to the display 162. Image processing unit may be employed to adjust the processed image before displaying.

A dynamic ranking module 1700 is coupled to the central control unit to analyze the most favorite communication destination, such as the most favorite contact person, the most favorite email contact person, the most favorite instant messaging contact person, or the most favorite website, the most favorite blog, or the most favorite FB. The dynamic ranking module 1700 ranks the contact information, websites or accounts based on the frequency of communication between the user and the communication destination (e.g., contact person) within a period of time or the frequency that the user accesses the communication destination (e.g., website) within a period of time. The period of time may be hours, days, weeks, months or seasons, etc. A selection interface may be provided in order for the user to choose. Therefore, the dynamic ranking module 1700 will have the communication or website accessing frequency data calculated by the dynamic ranking module 1700 or additional counter of the devices. It will rank the accounts or contact persons dynamically and automatically depending on the communication or accessing frequency or times and display the high ranking communication destination (contact person, website, or account) on the top or the first page of the user interface. The ranking module 1700 will re-arrange the queue of the communication destination (e.g., contact person) and its related information, such as phone number, e-mail address, user account dynamically based on the frequency of use. If the ranking is altered, the ranking module 1700 will change and re-arrange the queue of the communication destination (contact person, website, or account). In the prior art, the phone number is listed based on the alphabet. The people's name with alphabet A is always listed at the top of the list, however, the people is not necessarily high ranking. The dynamic ranking module 1700 can be used in the cellular phone to dynamically re-arrange the list of the address book, contact book or the phone number book based on the frequency of usage to allow the most high ranking person or website will be listed on the top of the list or first page of the user interface. The device also includes a phone filter module 1800 coupled to the central control unit. The phone filter module 1800 includes an interface on the display to allow the user to input the black list of person and corresponding phone number. When the signal of the incoming phone is received, the phone filter module 1800 will check whether or not the phone number is listed on the black list. If the incoming phone is already listed in the black list, the phone filter module 1800 will hand up the phone automatically without the user action or direct the phone into voice mail.

The present invention also provides a user action detection or control module to control the cursor without a mouse or trackpad. This computing device includes a display and a detecting device for detecting motion of the user. A movement information generating device is in response to the detection to generate an output signal, thereby generating movement information. A cursor control module is in response to the movement information to drive a cursor on the display corresponding to the movement information. Referring now to FIG. 3 to FIG. 6, there is shown in schematic form the basic components of the user motion control module 18500 incorporating the eye control module (or body control module) according to a preferred embodiment of the invention. The present invention comprises a step of detecting the motion of the user. Preferably, the portion for detection could be eye, face, limb or the like. The eye detection will be introduced as one of the examples to illustrate the features of present invention. The subject's face or eye is positioned relative to a sensor 18510 so that initially the subject's gaze is aligned along center line toward a pupil stimulus and fixation target. The user motion control module 18500 includes sensor 18510 and control unit 18515 to detect eye motion and generate a control signal. The face motion could be used to practice the present invention. A detecting source 18505 is provided, the pupil of the eye(s) is (are) illuminated by the detecting source 18505, for example, an infrared ray (IR) or light emitting diode (LED). Preferably, dual (or more) source LED is used to project two spatially separated spots at the subject's pupil. The dual source LED is constructed by placing two LED side by side on the panel of the portable device. Back light from the subject's eye is detected by a sensor 18510 directly or via other optical mirror or lens. Another method is to detect the user face or hand motion or image by the sensor 18510. The sensor 18510 could be optical sensor such as CMOS sensor or CCD sensor. The outputs from the sensor 18510 are input to a processor or control unit 18515 to generate a control signal to a cursor control module 18520 for controlling a cursor 18530 on the display or panel. Preferably, the detecting source 18505 or the like scans the position of the pupil of eye(s). In this process the pupil is illuminated by the detecting source 18505, so that the geometric form of the pupil can be portrayed clearly on the sensor 18510.

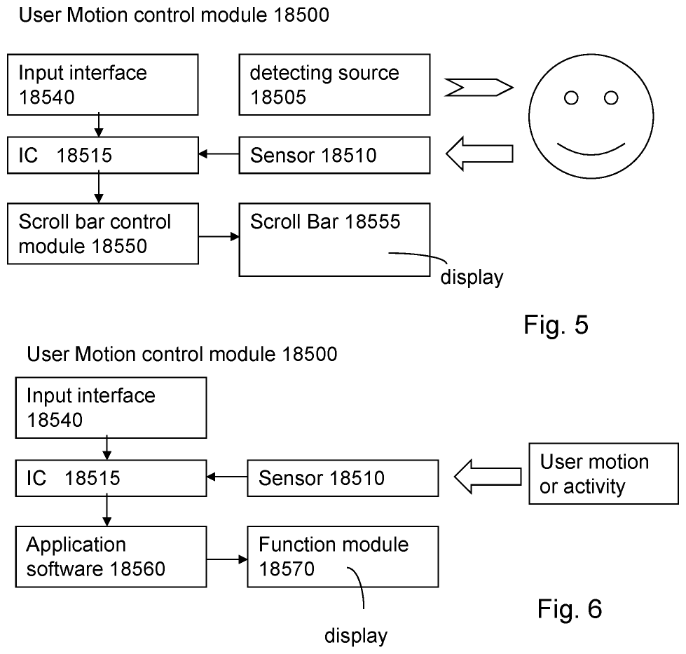

Alternatively, the image (face) change of the user could be detected by the present invention. By means of image processing, the pupil position information is evaluated and to determine where the eye in the display is looking. The control signal may drive the cursor 18530 to the position where the eyes are looking through cursor control module 18520. A buttons-image (or button-icons) 18535 may be generated along with the cursor 18530 by an image generator. In one case, the image generator may be a touch screen module 18525 which may generate touch screen image via well-known touch screen technology, in the manner, the user may “click on” the virtual button to input a command by means of “clicking” the touch screen. Alternatively, the click signal may be input from input interface 18540 such as (the right and left buttons of) the keypad, vocal control through microphone, eye motion through the sensor 18510. In the case of vocal control, another software/hardware may be necessary to process the steps of object selection through voice recognition hardware and/or software. For example, the action of close left eye refers to click left button while the action of close right eye refers to click right button. If both eyes close, it may refer to select one item from a list. The above default function may be practiced by a program or software. It should be understood by persons skilled in the art, the foregoing preferred embodiment of the present invention is illustrative of the present invention rather than limiting the present invention. Modification will now suggest itself to those skilled in the art. Under the method disclosed by the present invention, the user may move the cursor 18530 automatically without the mouse. Similarly, the control signal may be used to drive the scroll bar 18555 moving upwardly or downwardly without clicking the bar 18555 while reading document displayed on the screen, as shown in FIG. 5. Thus, the control signal generated by the control unit 18515 will be fed into the scroll bar control module 18550 to drive the scroll bar 18555 on the display moving upwardly or downwardly without the mouse or keypad. An eye controllable screen pointer is provided. The eye tracking signals are performed in a calculation by a processing means residing in a processor or the control unit 18515 to produce a cursor 18530 on the screen.

The sensor 18510 is electrically coupled to the control unit 18515 via line. In a preferred embodiment, the control unit 18515 comprises a semiconductor integrated circuit or chip configured to receive, interpret and process electrical signals, and to provide output electrical signals. Output signals from the control unit 18515 comprise signals indicative of movement of eye in a direction corresponding to the direction of actual cursor movement on the display intended by the user. The present embodiment takes into account a possible “dragging” situation that the user may be faced with. On occasion, some users have a need to “drag” an icon or other object from one area of the screen to another. On some computers, to accomplish this, the user must hold down the left click button and control the pointing device at the same time. If a touchpad is being used as the pointing device, and the object must a dragged a long distance across the screen, sometimes the user's finger may reach the edge of the touchpad. This situation is easily handled by the present invention. In such a situation, the control unit 18515 may send the command (e.g. “click left mouse button”, while dragging) repeatedly until the user's finger leaves a keyboard key (stops pressing a key). This permits dragging to be performed even after the user's finger leaves the touchpad. U.S. Pat. No. 7,165,225, assigned to Microsoft Corporation (Redmond, Wash.) disclosed “Methods and systems for cursor tracking in a multilevel GUI hierarchy”. U.S. Pat. No. 7,137,068, assigned to Microsoft Corporation (Redmond, Wash.) disclosed “Apparatus and method for automatically positioning a cursor on a control”.

Therefore, the present invention providing a method of pointing a mark such as cursor 18530, bar 18555 on a screen, the method includes detecting motion of a user (such as eye, face, body motion) and a sensor 18510 is in response to the detection of the eye to generate an output signal, thereby generating eye movement information; a cursor control module 18520 is in response to the user movement information to drive a cursor 18530 on the display corresponding to the movement information.

Similarly, the above method may be used for face tracing in the field of digital still camera or digital video camera to track the face of the subject. By the almost same scheme, a face indication (or mark) module 18545 is response to the control signal to mark the face on the screen, thereby tracking the face of the user for the digital camera. A digital camera comprises a control unit and a display; a detecting source 18505 for detecting eye of a user who is under photographed; a sensor 18510 in response to the detecting light back from the eye to generate an output signal, thereby generating eye movement information; a cursor control module 18520 in response to the eye movement information to drive a face indicator 18545 on the display corresponding to the eye movement information. The digital camera further comprises a wireless data transferring/receiving module coupled to the control unit for data transmission with an external device.

As aforementioned, the present invention discloses a user motion control (or detection) module 18500 for computer or portable device. The module could be incorporated into the device adjacent to the keypad or keyboard area. Then, it may detect the figure motion of the user to move the cursor 18530. Under some embodiments, the CMOS or CCD is used to detect the user motion including the facial expression, facial motion, or finger motion. In these applications, the sensor 18510 may capture the images and the controller may analyze the image change, thereby determining the movement of the cursor 18530. The user motion control (or detection) module 18500 may also be used to monitor and respond to the user's facial expressions, for example, the user's motion could be monitored with a still camera or a video camera. It is unlike the conventional track ball, control panel for notebook. The sensitivity, resolution and controllability of the control panel are not so good. It should be noted, in the embodiment, the user motion detecting module may be set adjacent to the keypad of notebook, or keyboard of the PC. The user motion detecting module detects the figure motion of the user by CMOS, CCD as aforementioned method. The resolution of the CMOS sensor may achieve higher than several Mega pixels. It may precisely reflect the finger (or face) motion of the user.

Alternatively, the cursor 18530 or items or function of computer (such as open file, close file, copy, cut, paste, etc.,) may be controlled by the user activity, such as through the measurement of the activity of the human brain. The EEG (electroencephalograph) records the voltage fluctuations of the brain which can be detected using electrodes attached to the scalp. The EEG signals arise from the cerebral cortex, a layer of highly convoluted neuronal tissue several centimeters thick. Alpha waves (8-13 Hz) that can be effected if the user concentrates on simple mentally isolated actions like closing one's eyes; Beta waves (14-30 Hz) are associated with an alert state of mind; Theta waves (4-7 Hz) are usually associated with the beginning of sleep state and frustration or disappointment; and Delta waves (below 3.5 Hz) are associated with deep sleep. Electromyographic (EMG) sensors are attached to the person's skin to sense and translate muscular impulses. Also Electrooculargraphic (EOG) signals have been sensed from eye movement. U.S. Pat. No. 7,153,279, assigned to George Washington University disclosed a brain retraction sensor. U.S. Pat. No. 7,171,262, assigned to Nihon Kohden Corporation disclosed a Vital sign display monitor.

FIG. 6 is a diagram of an illustrative embodiment of the invention. The neural activity is tracked on neural activity detecting device. Preferably, the neural activity tracked includes EEG, EOG, EMG activity. The electrical signals representative of the neural activity are transmitted via wired or wireless method to the control unit. If a predetermined signal is sensed by detecting device, the same EEG readings may be monitored. For example, the Alpha waves (8-13 Hz) can be effected if the user concentrates on some actions. Thus, if the concentration pattern is detected, the system is responsive to the signal and issue an instruction to take action to “open file”, “close file”, “copy file”, “click”, “paste”, “delete”, “space”, or “input characteristics” etc. It should be noted that the state patterns of potential users may be monitored before the system is used. The control unit 18515 is coupled to a signal receiver (not shown) which receives the neural signals from sensor 18510 by antenna or wired method. An operating system runs on CPU, provides control and is used to coordinate the function of the various components of system and Application programs 18560, so as to control the function module 18570. These programs include the programs for converting the received neural electrical signals into computer actions on the screen of display. By using the aforementioned devices, a user is capable of controlling the computer action by inputting neural information to the system through sensor 18510. The setting up of a program will be described in the following according to the present invention for a user to control a computer with sensed neural signals. A program is set up in the computer to use the electrical signals to control computer functions and/or functions controlled by the computer. A process is provided for predetermining the neural activity level (or pattern) that indicates the level of concentration of the user. A sensor 18510 is provided for monitoring a user's neural activity to determine when the predetermined neural activity level has been reached. The user's EEG pattern is determined. The user's neural activity is converted to electrical signals, so as to give an instruction to execute a software functions. Before the user EEG pattern is determined, an image sensor (CCD or CMOS) is introduced to monitor the facial motion (or eye motion) of the user to determine where the user looks at on the screen.

Therefore, the present invention discloses a method of controlling a cursor by user motion for a computing device comprising: detecting a user motion by detecting device; generating a control signal in response to the user motion detection; and controlling the cursor displayed on a display in response to the control signal. The user motion is detected by CMOS or CCD and the user motion includes facial motion, eye motion, or finger motion. The method further comprises a step of analyzing the user motion before generating the control signal. The analysis includes the analysis of image change of the user motion.

A method of instructing an object by user activity for a computing device comprises detecting a user activity by a detecting device; generating a control signal in response to the user activity detection; controlling the object displayed on a display in response to the control signal to execute the instruction. The user activity is detected by CMOS or CCD and the user activity includes facial motion, eye motion, or finger motion. The method further comprises a step of analyzing the user activity before generating the control signal. The analysis includes the analysis of image change of the user activity. Alternatively, the user activity is detected by EEG, EMG, or EOG sensor. The control signal includes cursor movement, character input, software application instruction.

A method of instructing an object by user activity for a computing device comprises detecting a user activity by a detecting device by CMOS or CCD; generating a control signal in response to the user activity detection; controlling the object displayed on a display in response to the control signal; and detecting a EEG, EMG, EOG pattern by a EEG, EMG, EOG sensor to execute an instruction.

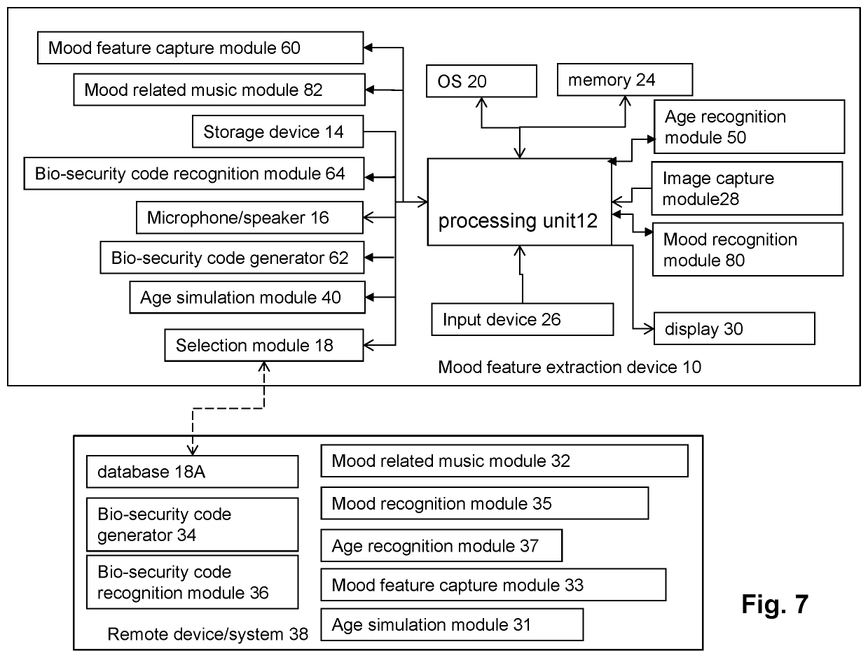

As shown in FIG. 7, it illustrates the mood feature extraction device with mood feature extraction and analysis function and the applying system thereof. The mood feature extraction device 10 may for example be a portable device, including computer, notebook, tablet PC, mobile phone, smart phone, game console, AR (Augmented Reality) device, VR (Virtual Reality) device, smart speaker, automobile sound box, and may include a processing unit 12 and a memory 24 coupled to the processing unit 12. The mood feature extraction device 10 may include a BIOS (Basic Input/Output System) which is a set of basic routines to transform data in the components within the mood feature extraction device 10. A storage device 14 such as hard disk or non-volatile memory may be coupled to the processing unit 12. The user can input instruction through an input device 26, for instance keypad, mouse or touch panel. A display 30 may be coupled to the processing unit 12. An operating system 20 and a selection module 18 may be stored in the computer readable medium. The selection module 18 may include music selection module or merchandise selection module. A remote device/system 38 includes a database 18A. The database 18A may include music database, merchandise database, etc. The music selection module 18 can select a music or song appropriate for the current user depending upon the established mood related music in the mood related music database 18A. The database can be established in the cloud or at the user end. The mood related music database 18A may be established in the cloud or at the user end, and may include music classification and mood classification, in order for the music selection module 18 to match the music with the user's mood behavior. The mood related music database 18A and the music selection module 18 may also be integrated into a single module depending on the demand.

Microphone and speaker 16 may be coupled to the processing unit 12. An image capture module (component) 28 may also be coupled to the processing unit 12. An age recognition module 50 may be coupled to the processing unit 12 to recognize the age of the user and generate an age recognition result via a captured facial image of the user. In one embodiment, the age recognition module 50 may be divided into two separate units such as an age simulation module 40 and an age recognition module 50. The portable device 10 of this embodiment may also include the components in FIG. 1 or FIG. 2, and therefore FIG. 7 omits the illustration thereof

The mood feature capture module 60 may be coupled to the processing unit 12 to extract and capture the mood features of the user. The mood recognition module 80 may be coupled to the processing unit 12 to recognize the captured mood features. In one embodiment, the mood feature capture module 60 and the mood recognition module 80 may be separate modules or applications. In another embodiment, the mood feature capture module 60 and the mood recognition module 80 may be integrated in a single module or application. The mood signal may be generated by capturing facial image via the image capture device or by capturing the EEG signal through the EEG sensor or vocal signal by the microphone. The mood feature capture module 60 and the mood recognition module 80 may be integrated or separately disposed at the user end and/or the remote apparatus.

A bio-security code generator 62 may be coupled to the processing unit 12 to generate a bio-security code of the user via the captured bio-characteristic of the user. A bio-security code recognition module 64 may be coupled to the processing unit 12 for bio-security code recognition. In one embodiment, the bio-security code generator 62 and the bio-security code recognition module 64 may be separate modules or applications. In another embodiment, the bio-security code generator 62 and the bio-security code recognition module 64 may be integrated in one module or application.

The mood feature capture module 33, the mood recognition module 35, the bio-security code generator 34, the bio-security recognition module 36, the age simulation module 31 and the age recognition module 37 may be disposed at the local terminal device or at the remote device/system 38 as shown in FIG. 7.

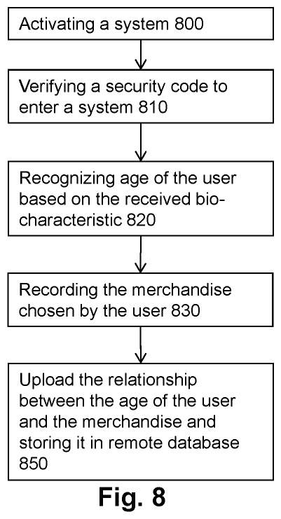

As shown in FIG. 8, it shows a flow chart of a device user logging in a system in accordance with the present invention. The present invention includes the following steps. Firstly, in step 800, a system is activated by a mood feature extraction device 10. The mood feature extraction device 10 may be for example mobile phone, smart phone, tablet PC, smart speaker, augmented reality (AR) device, virtual reality (VR) device, jukebox, automobile sound player device (automobile sound box), etc. The system may be local system or a system which transmits data via the network, such as network shopping system, shopping system, unmanned store system, jukebox system, network store, music website, music streaming system, (network) music playing system, etc.

Subsequently, in step 810, a security code is verified to enter the system. In one embodiment, the present invention introduces bio-characteristic to serve as the security code. Furthermore, the common text based password may also be employed as the security code. The system activates the device to collect the bio-characteristic of the user. The bio-characteristic includes face image, eye image, fingerprint or voice bio-characteristic. The face image, the eye image, the fingerprint bio-characteristic can be captured by image capturing device 28 while the voice bio-characteristic is collected by microphone 16. After the template of the bio-characteristic is captured or collected, the bio-characteristic may be stored in the mood feature extraction device 10 or the remote device/system 38. The age recognition module 50 may be optionally implemented. The age of the user may be simulated by employing the received bio-characteristic. In step 820, the received bio-characteristic may be utilized to recognize the age of the user. In step 830, the merchandise chosen by the user may be recorded; wherein the user may select a merchandise via the merchandise selection module 18. In step 840, the mood feature may be transmitted to a mood related merchandise module, and related merchandise may be recommended based on the mood feature. In step 850, the relationship between the age of the user and the merchandise may be uploaded and be stored in the remote database for big data analysis.

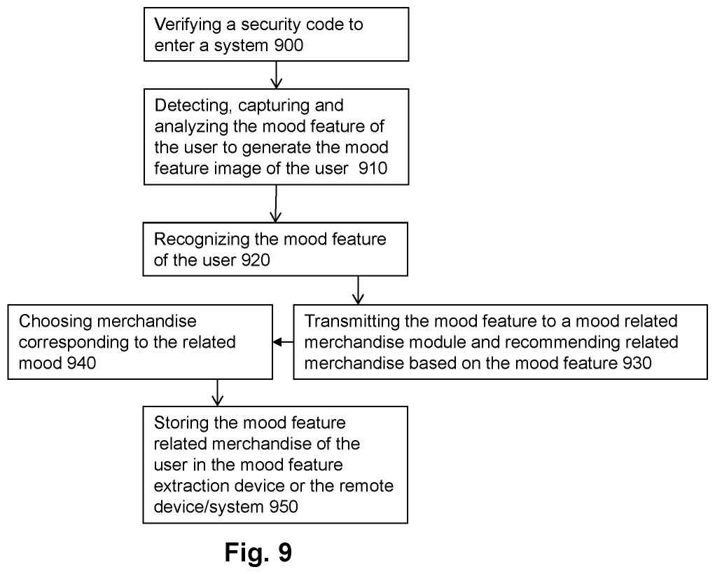

In another embodiment, with reference to FIG. 9, in step 900, a security code is verified to enter the system. In one embodiment, the present invention introduces bio-characteristic to serve as the security code. Furthermore, the common text based password may also be employed as the security code. The system activates the device to collect the bio-characteristic of the user. The bio-characteristic includes face image, eye image, fingerprint or voice bio-characteristic. The face image, the eye image, the fingerprint bio-characteristic can be captured by image capturing device 28 while the voice bio-characteristic is collected by microphone 16. After the template of the bio-characteristic is captured or collected, the bio-characteristic may be stored in the mood feature extraction device 10 or the remote device/system 38. Next, the mood feature of the user may be detected, captured and analyzed to generate the mood feature (expression) image of the user; the mood feature capture module 60 may be utilized to perform the analysis of the mood feature in step 910. The mood data are generated by capturing face image, voice signal, or EEG information. For example, the mood expressed by the face may be analyzed. Then, in step 920, the mood feature of the user may be recognized based on the analyzed mood feature (expression) image data of the user, mood voice signal. For instance, the mood expressed by the face or the voice may be recognized. After the recognition, what kind of mood the mood expression of the user belongs to may be determined, such as anger, contempt, aversion, happiness, smile, laughing loud, no comment, distress, sadness, surprise, etc. In step 930, the mood feature may be transmitted to a mood related merchandise module, and related merchandise may be recommended based on the mood feature. In step 940, the merchandise corresponding to the related mood may be chosen. Subsequently, in step 950, the mood feature related merchandise of the user may be stored in the mood feature extraction device 10 or the remote device/system 38 for big data analysis.

The present invention employs the big data database with age integrated with mood and corresponding merchandise (or music) to provide better and more convenient communication interface. Thus, the user can automatically transmit or play or recommend a merchandise (or music) by the mood feature extraction device or the remote device via the age or mood feature. As a result, the present invention provides more convenient interface for the user to obtain the recommended merchandise or music, which can be applied to for example unmanned store, network store, music website, music streaming system, smart speaker, automobile sound box, jukebox device, AR device, VR device, etc.

Moreover, when the user activates an applying system, the bio-characteristic capturing module will be triggered to automatically fetch the current bio-characteristic of the user, followed by accessing the applying system when the system identifies the user. Further, the user may refresh the template of the bio-characteristic by using new captured bio-characteristic.

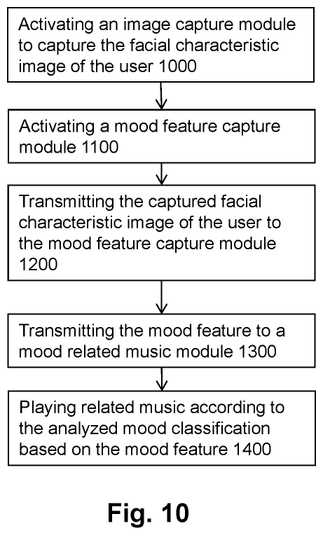

With reference to FIG. 10, which illustrates a flow chart of applying the mood feature capture module in accordance with the present invention. Firstly, in step 1000, an image capture module 28 may be activated to capture the facial characteristic image (vocal signal or EEG detection may also be used). The image capture module 28 may include image sensor. The facial characteristic image of the user may be stored in the memory 24 of the mood feature extraction device 10. The image capture module 28 is the image capture module of the mood feature extraction device or unmanned store or jukebox device; the mood feature extraction device may be connected to network store, music website, music streaming system; or the mood feature extraction device may include smart speaker, jukebox device, AR device, VR device, automobile sound box, etc. In step 1100, a mood feature capture module 60 or 33 may be activated by the mood feature extraction device 10 or unmanned store or jukebox device. Subsequently, in step 1200, the captured characteristic image (voice signal or EEG signals) of the user may be transmitted to the mood feature capture module 60 or 33 to analyze the mood of the user and determine the mood classification of the user. In one example, the mood feature capture module 60 or 33 and the mood recognition module 80 or 35 may be utilized to determine the mood of the user. The mood parameter or index or the mood simulated shape of face of the user may be displayed on the display 30; the mood simulated shape of face may be completed by the mood recognition module 80 or 35. In step 1300, after the mood of the user is analyzed, the mood feature is transmitted to a mood related music module, wherein the mood related music module 82 or 32 is disposed in the mood feature extraction device 10 or the remote device 38. In step 1400, related music is played according to the analyzed mood classification based on the mood feature; for instance, music related to the mood may be (automatically) chosen from the mood related music database 18A by the music selection module 18 so as to be played. For example, the chosen music may be transmitted by the music playing center (system) to the mood feature extraction device 10, or the music stored in the mood feature extraction device 10 may be played in the mood feature extraction device 10. The mood related music database 18A may include music classification and mood classification, in order for the music selection module 18 to match the music with the user's mood behavior. In other words, certain mood is related to one music classification chosen by the music selection module and associated with the mood, in order for e.g. the smart speaker, jukebox, automobile sound player device, music playing system to play the chosen music. In another example, after the facial mood of the user is analyzed, related merchandise is recommended based on the analyzed mood classification; for example, merchandise related to the mood may be (automatically) chosen by the merchandise selection module for the user's reference or for the user to buy, such as merchandise in network shopping system, shopping system, unmanned store system, etc. That is to say, certain mood is related to one merchandise classification chosen by the merchandise selection module and associated with the mood.

Messages or data may be communicated between the mood feature extraction device 10 and the remote device or system 38 through the wireless transmission module or the Internet transmission module.

As will be understood by persons skilled in the art, the foregoing preferred embodiment of the present invention is illustrative of the present invention rather than limiting the present invention. Having described the invention in connection with a preferred embodiment, modification will now suggest itself to those skilled in the art. Thus, the invention is not to be limited to this embodiment, but rather the invention is intended to cover various modifications and similar arrangements included within the spirit and scope of the appended claims, the scope of which should be accorded the broadest interpretation so as to encompass all such modifications and similar structures. While the preferred embodiment of the invention has been illustrated and described, it will be appreciated that various changes can be made therein without departing from the spirit and scope of the invention.

What is claimed is:

1. A mood feature extraction device comprising:
a control unit;
a memory coupled to said control unit; and
a mood feature capture module coupled to said control unit to capture a mood feature of a user and activate a selection module based on said mood feature.

2. The device according to claim 1, wherein said selection module comprises a music selection module or a merchandise selection module.

3. The device according to claim 1, wherein said selection module is disposed in network store, music website, music streaming system, unmanned store, jukebox device or said mood feature extraction device.

4. The device according to claim 3, wherein said mood feature extraction device comprises smart phone, tablet PC, smart speaker, augmented reality (AR) device, virtual reality (VR) device or automobile sound box.

5. The device according to claim 1, further comprising a mood recognition module disposed in network store, music website, music streaming system, unmanned store, jukebox device or said mood feature extraction device.

6. The device according to claim 5, wherein said mood feature extraction device comprises smart phone, tablet PC, smart speaker, augmented reality (AR) device, virtual reality (VR) device or automobile sound box.

7. The device according to claim 1, further comprising a mood related merchandise database or a mood related music database disposed in network store, music website, music streaming system, unmanned store, jukebox device or said mood feature extraction device.

8. The device according to claim 7, wherein said mood feature extraction device comprises smart phone, tablet PC, smart speaker, augmented reality (AR) device, virtual reality (VR) device or automobile sound box.

9. The device according to claim 1, wherein said mood feature comprises face image, voice signal or EEG (electroencephalograph) signal.

10. A mood feature extraction device comprising:
a control unit;
a memory coupled to said control unit;
a mood feature capture module coupled to said control unit to capture a mood feature of a user;
a mood recognition module coupled to said mood feature capture module to determine said captured mood feature; and
a selection module coupled to said control unit to be activated for selecting based on said mood feature.

11. The device according to claim 10, wherein said selection module comprises a music selection module or a merchandise selection module.

12. The device according to claim 10, wherein said selection module is disposed in network store, music website, music streaming system, unmanned store, jukebox device or said mood feature extraction device.

13. The device according to claim 12, wherein said mood feature extraction device comprises smart phone, tablet PC, smart speaker, augmented reality (AR) device, virtual reality (VR) device or automobile sound box.

14. The device according to claim 10, further comprising a mood recognition module disposed in network store, music website, music streaming system, unmanned store, jukebox device or said mood feature extraction device.

15. The device according to claim 10, further comprising a mood related merchandise database or a mood related music database disposed in network store, music website, music streaming system, unmanned store, jukebox device or said mood feature extraction device.

16. The device according to claim 10, wherein said mood feature extraction device comprises smart phone, tablet PC, smart speaker, augmented reality (AR) device, virtual reality (VR) device or automobile sound box.

17. The device according to claim 10, wherein said mood feature comprises face image, voice signal or EEG (electroencephalograph) signal.
